(19) United States
(12) Patent Application Publication
(10) Pub. No.: US 2026/0299237 A1
(43) Pub. Date: Oct. 1, 2026

(54) FIBER OPTIC PULLING ASSEMBLY

(71) Applicant: CommScope Technologies LLC, Claremont, NC (US)

(72) Inventors: Kenneth SKLUZACEK, Belle Plaine, MN (US); David R. WURST, Minneapolis, MN (US)

(73) Assignee: CommScope Technologies LLC, Claremont, NC (US)

(21) Appl. No.: 19/479,086

(22) PCT Filed: May 1, 2024
(86) PCT No.: PCT/US2024/027240

§ 371 Date: Oct. 27, 2025

Related U.S. Application Data
(60) Provisional application No. 63/499,376, filed on May 1, 2023.

(51) Int. Cl. G02B 6/44; G02B 6/04

(52) U.S. Cl. CPC G02B 6/443; G02B 6/04; G02B 6/4435; G02B 6/4479

(57) ABSTRACT

A fiber optic assembly that includes a breakout assembly, a plastic sleeve, a first mesh sleeve, and a crush resistant jacket. The first mesh sleeve facilitates assembly of the fiber optic assembly by providing a surface with a low frictional resistance for the crush resistant jacket to slide over. The breakout assembly further includes a second mesh sleeve. The second mesh sleeve is secured around the fiber optic assembly and includes a pulling loop at an end of the second mesh sleeve for pulling the fiber optic assembly.

### CROSS-REFERENCE TO RELATED APPLICATION

This application claims the benefit of and priority to U.S. Provisional Application No. 63/499,376, filed May 1, 2023, the disclosure of which is incorporated herein by reference in its entirety.

### BACKGROUND

Telecommunications systems typically employ a network of telecommunication cables capable of transmitting large volumes of data over relatively long distances. The telecommunications cables can include fiber optic cables, electrical cables, or combinations of electrical and fiber optic cables. Fiber optic cables may be organized in a breakout assembly. The purpose of a breakout assembly is to break out fiber optic cables and connectorize the fiber optic cables to a connector or other components such as a fiber optic patch panel. Breakout assemblies may include a very large quantity of fiber optic cables that must be stored in a limited space. Accordingly, improvements in organization and functionality are desirable.

### SUMMARY

In general terms, this disclosure is directed to a fiber optic pulling assembly. In some embodiments, and by non-limiting example, the fiber optic assembly includes an inner cable breakout assembly, a plastic sleeve around the inner cable breakout assembly, a first mesh sleeve around the plastic sleeve, and a crush resistant jacket around the first mesh sleeve.

In some examples, the first mesh sleeve helps to facilitate assembly and disassembly of the fiber optic pulling assembly by reducing the diameter of the plastic sleeve and the inner cable breakout assembly, and/or lowering the level of friction when sliding the crush resistant jacket onto or off of the assembly.

In some examples, a second mesh sleeve is positioned around the crush resistant jacket.

In some examples, a fiber optic assembly includes a plurality of fiber optic cables, forming an inner cable breakout assembly. The fiber optic assembly further includes a plastic sleeve around the inner cable breakout assembly. The fiber optic assembly further includes a first mesh sleeve around the plastic sleeve. The fiber optic assembly further includes a crush resistant jacket around the first mesh sleeve. The fiber optic assembly further includes a second mesh sleeve around the crush resistant jacket.

In some examples, a method of assembling a fiber optic assembly includes pulling a plastic sleeve over a plurality of fiber optic cables. The plurality of fiber optic cables forms an inner cable breakout assembly. The method further includes pulling a mesh sleeve over the plastic sleeve. The mesh sleeve may be pulled longitudinally to compress against the plastic sleeve to remove trapped air and make the plastic sleeve smaller in diameter. The method further includes pulling a crush resistant jacket over the mesh sleeve. A second mesh sleeve may be pulled over the crush resistant jacket.

### BRIEF DESCRIPTION OF THE DRAWINGS

FIG. 1 depicts an example fiber optic assembly.

FIG. 2 is an exploded view of the fiber optic assembly of FIG. 1.

FIG. 3 depicts an example breakout assembly of the fiber optic assembly of FIG. 1.

FIG. 4 is a schematic of another example breakout assembly of the fiber optic assembly of FIG. 1.

FIG. 5 depicts an example plastic sleeve of the fiber optic assembly of FIG. 1. FIG. 6 depicts an example first mesh sleeve of the fiber optic assembly of FIG. 1.

FIG. 7 depicts an example crush resistant jacket of the fiber optic assembly of FIG. 1.

FIG. 8 depicts an example second mesh sleeve of the fiber optic assembly of FIG. 1.

FIG. 9 is a flowchart that depicts an example method of making the fiber optic assembly of FIG. 1.

FIG. 10 depicts the example breakout assembly of FIG. 3 arranged within the plastic sleeve of FIG. 5.

FIG. 11 is a schematic of a breakout assembly arranged within a plastic sleeve.

FIG. 12 depicts the first end of the plastic sleeve of FIG. 5 closed over the first end of the breakout assembly of FIG. 3.

FIG. 13 depicts the first mesh sleeve of FIG. 6 secured over the plastic sleeve of FIG. 5.

FIG. 14 is a schematic of a first mesh sleeve secured over a plastic sleeve.

FIG. 15 depicts a closed first end of the first mesh sleeve of FIG. 6.

FIG. 16 depicts a closed second end of the first mesh sleeve of FIG. 6.

FIG. 17 is a schematic of a first mesh sleeve secured over a plastic sleeve.

FIG. 18 depicts a zoomed in view of the closed second end of the plastic sleeve of FIG. 5.

FIG. 19 depicts the crush resistant jacket of FIG. 7 arranged over the first mesh sleeve of FIG. 6.

FIG. 20 is a schematic of a crush resistant jacket arranged over a first mesh sleeve.

FIG. 21 is a schematic of a crush resistant jacket with a first end and the second end of the crush resistant jacket secured.

FIG. 22 depicts a zoomed in view of a closed first end of the crush resistant jacket of FIG. 7.

FIG. 23 depicts a zoomed in view of a closed second end of the crush resistant jacket of FIG. 7.

FIG. 24 is a schematic of a crush resistant jacket with a first end and a second end of the crush resistant jacket covered in weather resistant silicon tape.

FIG. 25 depicts the fiber optic assembly of FIG. 1 with the second mesh sleeve of FIG. 8 arranged over the crush resistant jacket of FIG. 7 with the ends of the second mesh sleeve closed.

FIG. 26 depicts a closed first end of the second mesh sleeve of FIG. 8.

FIG. 27 is a flowchart that depicts an example method of closing a first end of a second mesh sleeve.

FIG. 28 depicts the second mesh sleeve of FIG. 8 arranged over the breakout assembly of FIG. 3, the plastic sleeve of FIG. 5, the first mesh sleeve of FIG. 6, and the crush resistant jacket of FIG. 7 with a slack portion of the second mesh sleeve at the first end of the second mesh sleeve.

FIG. 29 depicts the second mesh sleeve of FIG. 8 with a first fold.

FIG. 30 depicts the second mesh sleeve of FIG. 8 with a second fold.

FIG. 31 is a bottom view of a third length of the second mesh sleeve of FIG. 8.

FIG. 32 is a perspective view of the pulling loop of the second mesh sleeve of FIG. 8 with the cable ties shown in a pre-wrapped orientation.

FIG. 33 is a side view of the pulling loop of the second mesh sleeve of FIG. 8.

FIG. 34 is another side view of the pulling loop of the second mesh sleeve of FIG. 8.

FIG. 35 is a flowchart that depicts an example method of closing the second end of a second mesh sleeve.

FIG. 36 is a depicts the second end of the second mesh sleeve of FIG. 8 with the second mesh sleeve secured at a first point.

FIG. 37 depicts the second mesh sleeve of FIG. 8 with the second length folded back over a portion of the first length and secured at a second point.

FIG. 38 depicts the second mesh sleeve in the configuration of FIG. 37 with the zip tie secured around the second mesh sleeve.

FIG. 39 depicts the second end of the of the second mesh sleeve of FIG. 8 with a reinforced second point.

FIG. 40 depicts the second end of the second mesh sleeve of FIG. 8 with the third length folded back over the second point and the first point and secured thereabout.

### DETAILED DESCRIPTION

Various embodiments will be described in detail with reference to the drawings. Reference to various embodiments does not limit the scope of the claims attached hereto. Additionally, any examples set forth in this specification are not intended to be limiting and merely set forth some of the many possible embodiments for the appended claims.

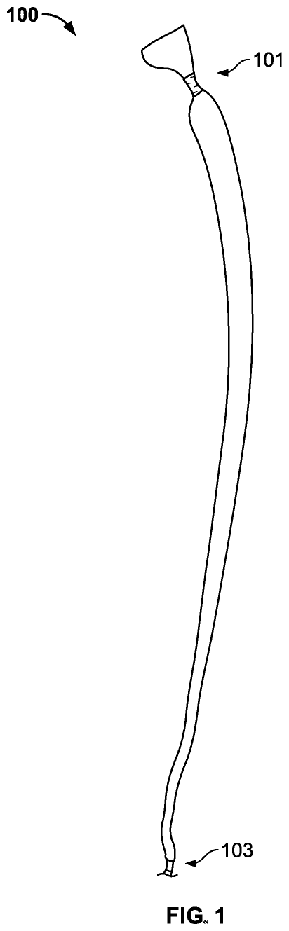

FIG. 1 depicts an example fiber optic pulling assembly, or a fiber optic assembly 100. In some examples, the fiber optic assembly 100 includes a first end 101 and a second end 103. In some examples, the fiber optic assembly 100 includes a plurality of layers that surround a breakout assembly 110. The fiber optic assembly 100 is used for pulling the breakout assembly 110 through an environment to a destination. In some examples, the fiber optic assembly 100 provides protection to the breakout assembly 110 secured therein when the fiber optic assembly 100 is pulled through rugged environmental conditions. In some examples, the fiber optic assembly 100 is less than two inches in diameter and is able to be pulled through a two-inch diameter conduit.

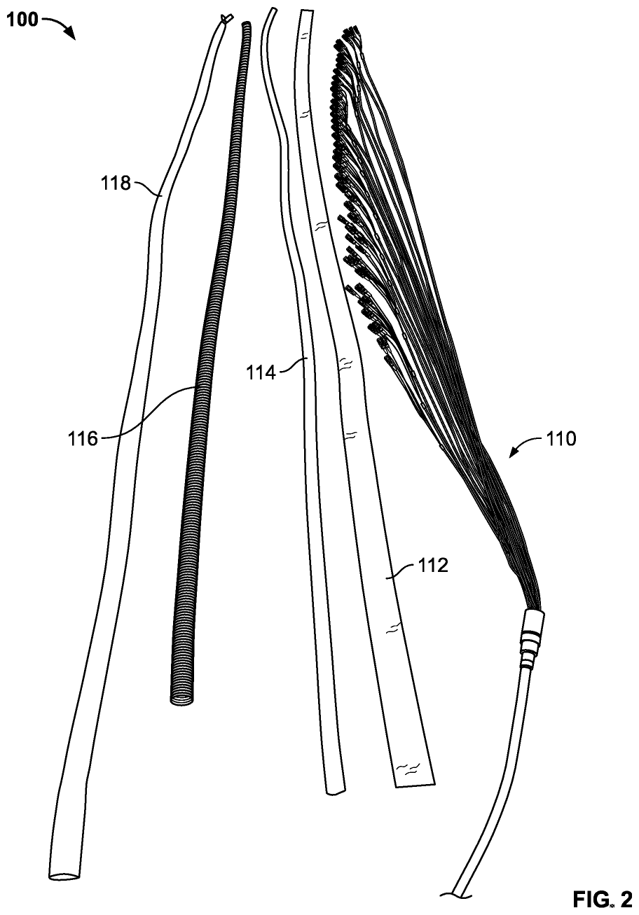

FIG. 2 is an exploded view of an example fiber optic assembly 100. The fiber optic assembly 100 includes a breakout assembly 110, a plastic sleeve 112, a first mesh sleeve 114, a crush resistant jacket 116, and a second mesh sleeve 118. In some examples, the fiber optic assembly 100 is arranged such that the second mesh sleeve 118 is arranged around the crush resistant jacket 116, the crush resistant jacket 116 is arranged around the first mesh sleeve 114, the first mesh sleeve 114 is arranged around the plastic sleeve 112, and the plastic sleeve 112 is arranged around the breakout assembly 110.

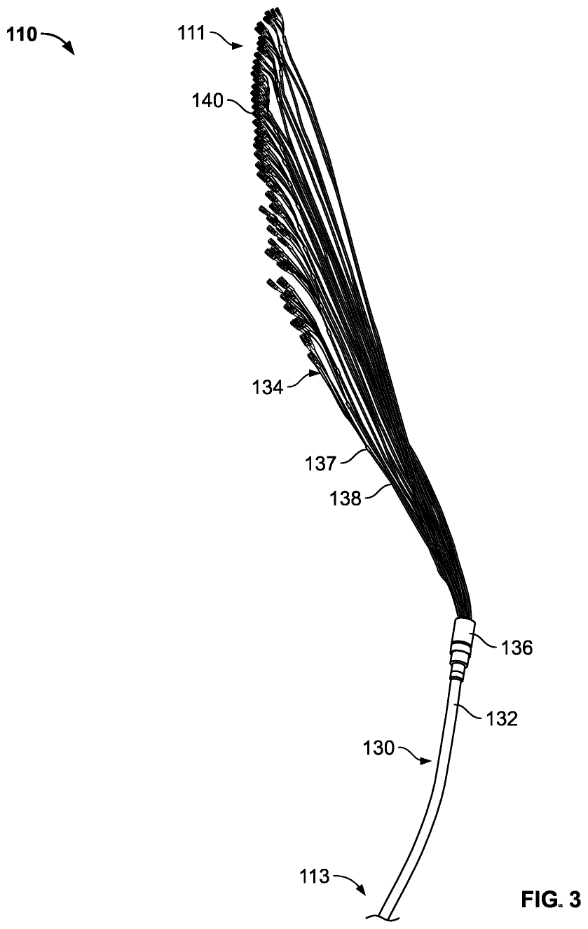

FIG. 3 depicts an example breakout assembly 110. In the example of FIG. 3, the breakout assembly includes multifiber connectors.

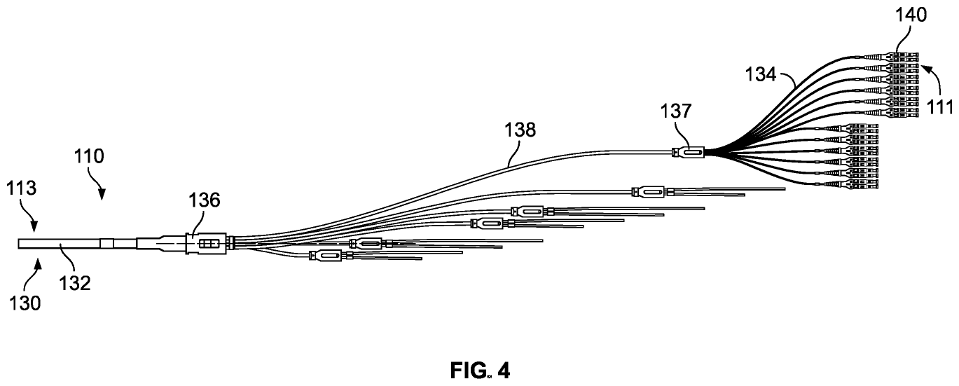

FIG. 4 is a schematic depiction of another example breakout assembly 110. In the example of FIG. 4, the breakout assembly 110 includes multifiber connectors.

The breakout assembly 110 includes a first end 111 and a second end 113. The breakout assembly 110 further includes a main cable 130 having a cable jacket 132 containing a plurality of optical fibers.

In some examples, the optical fibers transition from the cable jacket 132 at a first transition housing 136. In some examples, the breakout assembly 110 further includes one or more first furcation tubes 138. In some examples, each of the first furcation tubes 138 contains at least one of the optical fibers. In some examples, each of the furcation tubes 138 contains a plurality of the optical fibers (e.g., 2 optical fibers, 4 optical fibers, 8 optical fibers, 12 optical fibers, 24 optical fibers, etc.). In some examples, each of the first furcation tubes 138 is a mesh sleeve.

In some examples, the optical fibers transition from the first furcation tubes 138 at second transition housing 137. In some examples, the breakout assembly 110 further includes one or more second furcation tubes 134. In some examples, each of the second furcation tubes 134 contains a plurality of the optical fibers (e.g., 2 optical fibers, 4 optical fibers, 8 optical fibers, 12 optical fibers, 24 optical fibers, etc.). In some examples, each of the second furcation tubes 134 is tubular overtube, such as a polymer tube.

Each of the optical fibers is terminated by a fiber optic connector 140. In the depicted example, the fiber optic connectors 140 are multi-fiber connectors (e.g., MPO connectors) each having a ferrule capable of supporting a plurality of optical fibers. In alternative examples such as single-fiber examples, the optical fibers can be terminated by single-fiber connectors such as SC connectors or LC connectors. In some examples, the breakout assembly 110 is a 2880 or a 3456 fiber cable terminated with MPO24 connectors.

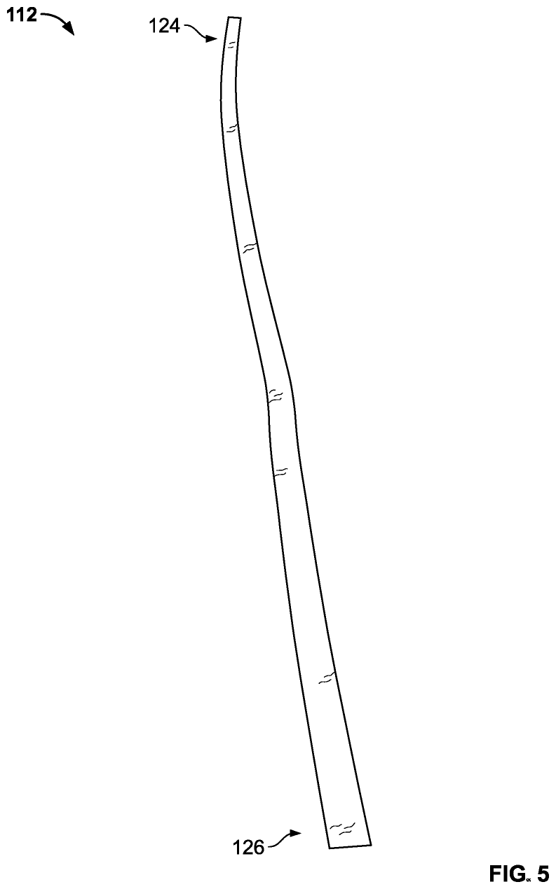

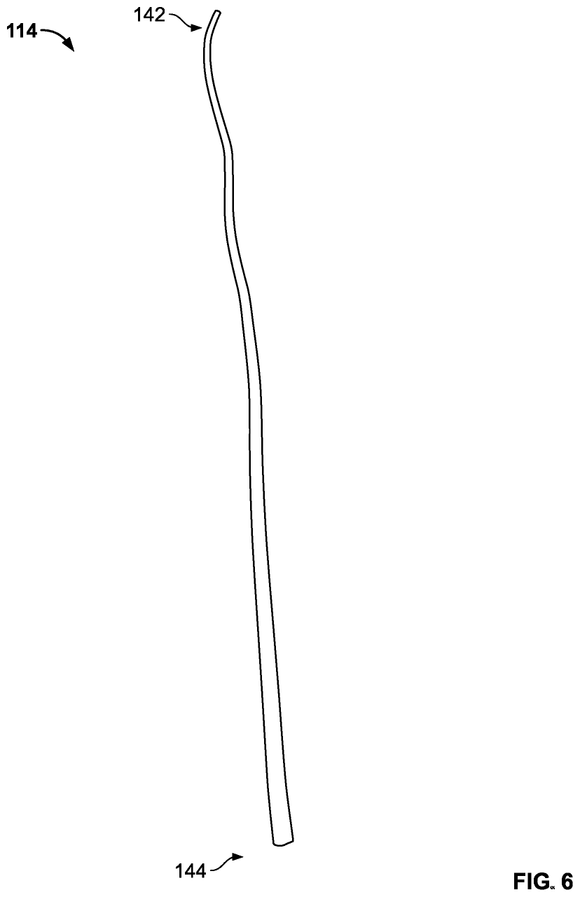

FIG. 5 depicts an example plastic sleeve 112. As shown in FIG. 5, the plastic sleeve 112 includes a first end 124 and a second end 126. In some examples, the plastic sleeve 112 is weather resistant and/or moisture resistant. As shown in FIG. 5, in some examples, the plastic sleeve 112 is a clear plastic sleeve. In some examples, the first end 124 and the second end 126 are open. In other examples, the first end 124 is closed.

FIG. 6 depicts an example first mesh sleeve 114. As shown in FIG. 6, the first mesh sleeve 114 includes a first end 142 and a second end 144. In some examples, the first end 142 and the second end 144 are open. In other examples, the first end 142 is closed. In some examples, the first mesh sleeve 114 is a mesh layer that has an inner diameter that can expand and contract.

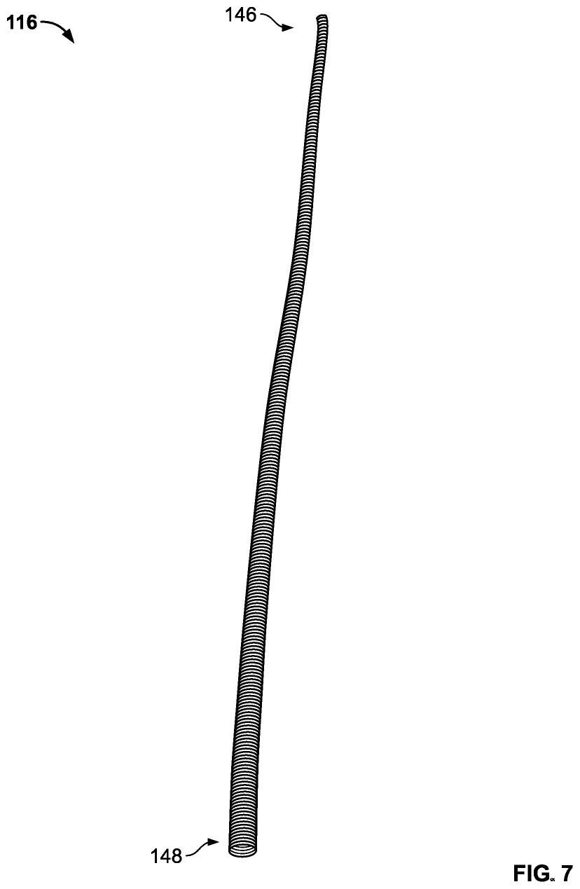

FIG. 7 depicts an example crush resistant jacket 116. As shown in FIG. 7, the crush resistant jacket 116 includes a first end 146 and a second end 148. In some examples, the first end 146 and the second end 148 are open. In other examples, the first end 146 is closed. In some examples, the crush resistant jacket 116 is made from a polyurethane material with a helical wire frame. In some examples, the crush resistant jacket is made from corrugated tubing.

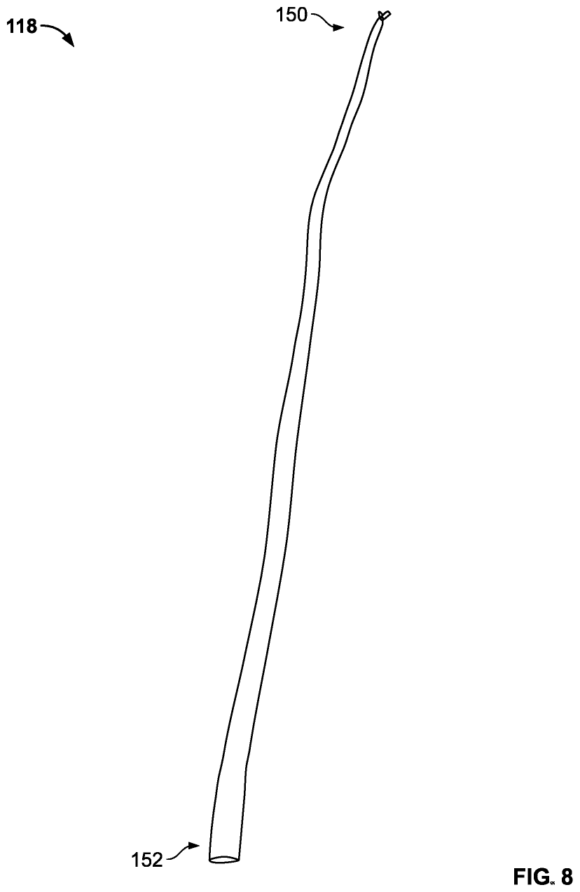

FIG. 8 depicts an example second mesh sleeve 118. As shown in FIG. 8, the second mesh sleeve 118 includes a first end 150 and a second end 152. In some examples, the first end 150 and the second end 152 are open. In other examples, the first end 150 is closed. In some examples, the second mesh sleeve 118 is a mesh layer that has an inner diameter that can expand and contract.

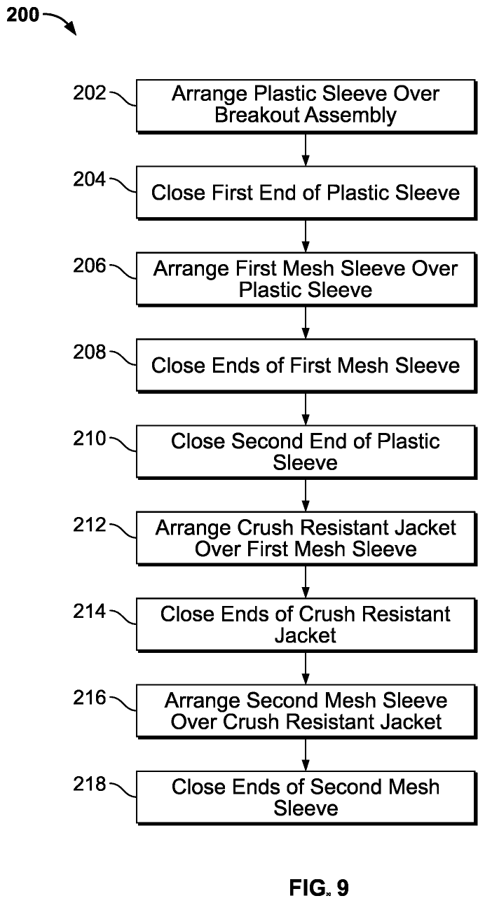

FIG. 9 is a flowchart that depicts an example method 200 of making the fiber optic assembly 100. In some examples, the method 200 includes operations 202, 204, 206, 208, 210, 212, 214, 216, and 218.

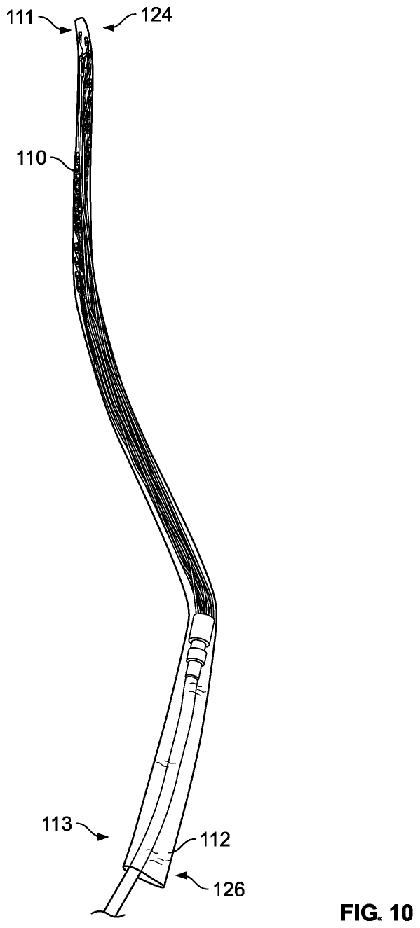

FIG. 10 depicts the breakout assembly 110 arranged within the plastic sleeve 112, as formed in operation 202.

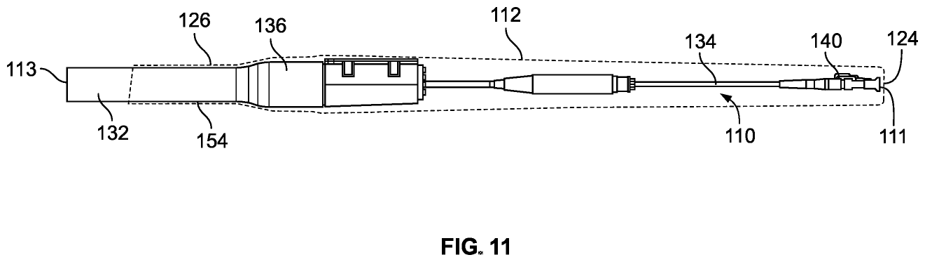

FIG. 11 is a schematic of the breakout assembly 110 arranged within the plastic sleeve 112.

Operation 202 includes arranging the plastic sleeve 112 over the breakout assembly 110. In some examples, operation 202 includes inserting the first end 111 of the breakout assembly 110 into the second end 126 of the plastic sleeve 112 and pulling the plastic sleeve 112 over the breakout assembly 110 until the first end 124 of the plastic sleeve 112 is adjacent the first end 111 of the breakout assembly 110. In other examples, operation 202 includes inserting the second end 113 of the breakout assembly 110 into the first end 124 of the plastic sleeve 112 and pulling the plastic sleeve over the breakout assembly 110 until the first end 124 of the plastic sleeve 112 is adjacent the first end 111 of the breakout assembly 110. In some examples, the plastic sleeve 112 extends over the first end 111 of the breakout assembly 110. In some examples, the plastic sleeve 112 is sufficiently long such that when the first end 124 of the plastic sleeve 112 is arranged adjacent the first end 111 of the breakout assembly 110, the plastic sleeve 112 covers the first transition housing 136 of the breakout assembly 110 and the second end 126 is arranged over the cable jacket 132 of the main cable of the breakout assembly 110.

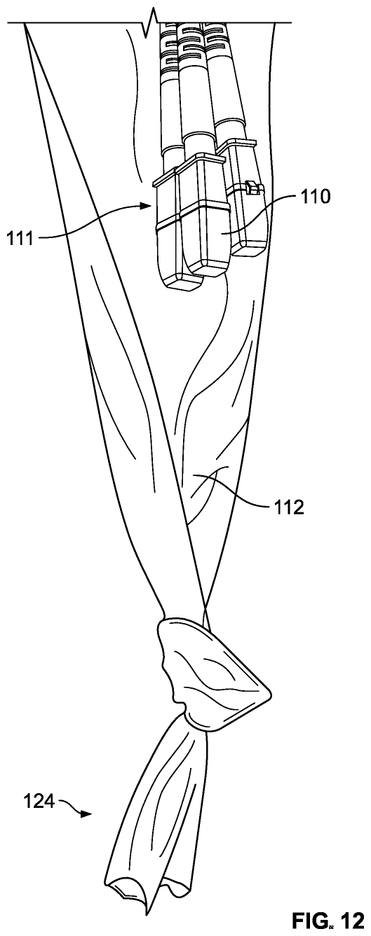

FIG. 12 depicts the first end 124 of the plastic sleeve 112 closed over the first end 111 of the breakout assembly 110, as formed in operation 204. Operation 204 includes closing the first end 124 of the plastic sleeve 112. In some examples, as shown in FIG. 12, the first end 124 of the plastic sleeve 112 is closed by tying a knot in the plastic sleeve 112. In other examples, the first end 124 of the plastic sleeve 112 is closed by various other methods such as, for example, tape or heat shrink. In some examples, operation 204 is performed after operation 202 is completed. In other examples, operation 204 is performed before operation 202. In some examples, closing the first end 124 of the plastic sleeve 112 includes forming a watertight seal at the first end 124 such that water cannot enter the interior of the plastic sleeve 112 through the first end 124 of the plastic sleeve 112.

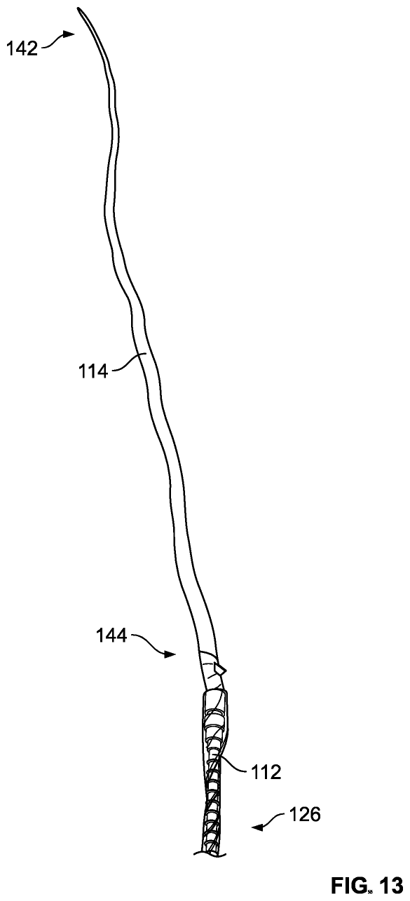

FIG. 13 depicts the first mesh sleeve 114 secured over the plastic sleeve 112, as formed in operations 206 and 208.

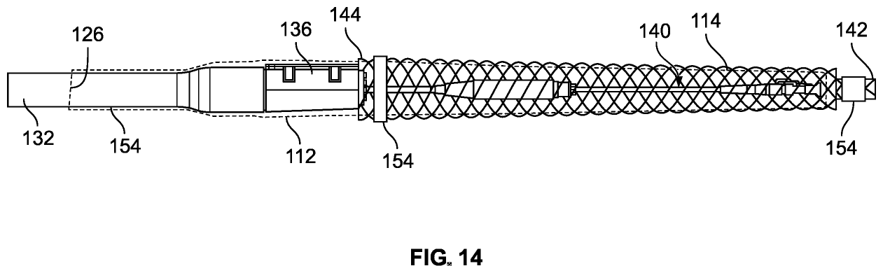

FIG. 14 is a schematic of the first mesh sleeve 114 secured over the plastic sleeve 112, as formed in operations 206 and 208.

Operation 206 includes arranging the first mesh sleeve 114 over the plastic sleeve 112. In some examples, the first mesh sleeve 114 is arranged over the plastic sleeve 112 while the plastic sleeve 112 is arranged over the breakout assembly 110 and the first end 124 of the plastic sleeve 112 is closed. In some examples, the first mesh sleeve 114 has a variable diameter. In some examples, the diameter of the first mesh sleeve 114 can be expanded by pushing the first end 142 of the first mesh sleeve 114 towards the second end 144 of the first mesh sleeve 114. In some examples, the diameter of the first mesh sleeve 114 can be decreased by pulling the first end 142 of the first mesh sleeve 114 away from the second end 144 of the first mesh sleeve 114.

In some examples, the diameter of the first mesh sleeve 114 is increased before arranging the first mesh sleeve 114 over the plastic sleeve 112 in order to facilitate sliding the first mesh sleeve 114 over the plastic sleeve 112. In some examples, arranging the first mesh sleeve 114 over the plastic sleeve 112 includes inserting the first end 124 of the plastic sleeve 112 into the second end 144 of the first mesh sleeve 114 and sliding the first mesh sleeve 114 over the plastic sleeve 112 until the first end 142 of the first mesh sleeve 114 is arranged adjacent to the first end 124 of the plastic sleeve 112. In some examples, the first mesh sleeve 114 extends over the first end 124 of the plastic sleeve 112. In some examples, the first mesh sleeve 114 exerts a compressive force over the plastic sleeve 112 as it is slid over the plastic sleeve 112. This provides the benefit of causing the air within the plastic sleeve 112 to be squeezed out of the plastic sleeve 112 through the second end 126 of the plastic sleeve as the first mesh sleeve 114 is slid over the plastic sleeve 112 from the first end 124 of the plastic sleeve 112 to the second end 126 of the plastic sleeve 112. In some examples, after the first mesh sleeve 114 is arranged over the plastic sleeve 112, the first mesh sleeve 114 is pulled tight so as to decrease the diameter of the first mesh sleeve 114 and exert a compressive force over the plastic sleeve 112 to reduce the volume inside of plastic sleeve 112 by helping to force out trapped air.

In some examples, the first mesh sleeve 114 is shorter than the plastic sleeve 112. In such examples, when the first mesh sleeve 114 is arranged over the plastic sleeve 112 and the breakout assembly 110 with the first end 142 of the first mesh sleeve 114 arranged adjacent to the first end 124 of the plastic sleeve 112, the first mesh sleeve 114 extends over the plastic sleeve 112 such that the second end 144 of the first mesh sleeve 114 is arranged between the first end 124 and the second end 126 of the plastic sleeve 112. In some examples, the second end 144 of the first mesh sleeve 114 is arranged between the first end of the breakout assembly 110 and the first transition housing 136.

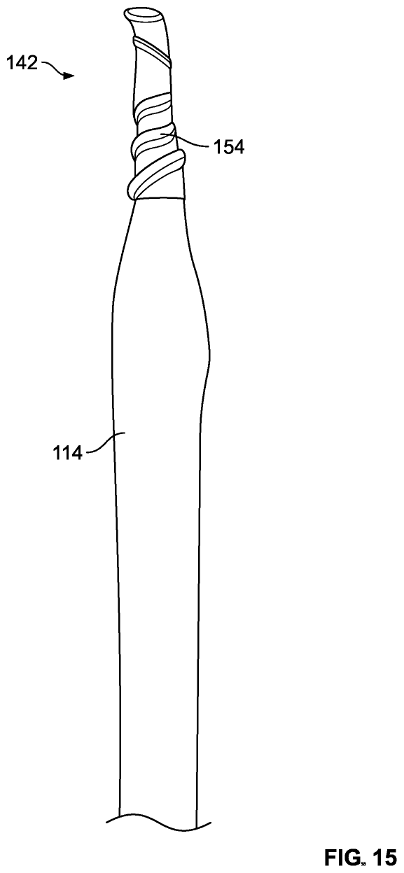

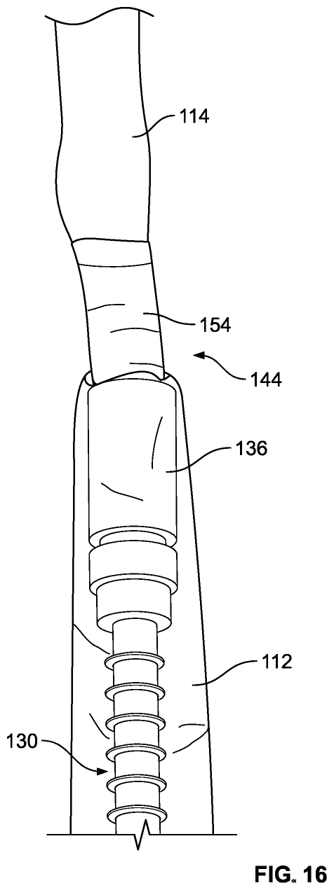

FIGS. 15 and 16 depict closed ends of the first mesh sleeve 114, as formed in operation 208. Operation 208 includes closing the first end 142 and the second end 144 of the first mesh sleeve 114 over the plastic sleeve 112.

FIG. 15 depicts the closed first end 142 of the first mesh sleeve 114. As shown in FIG. 15, the first end 142 of the first mesh sleeve 114 is closed with tape 154 wrapped around the first end 142 of the first mesh sleeve 114. In other examples, the first end 142 of the first mesh sleeve 114 is closed using other methods, such as tying a knot, using cable ties, or using heat shrink. In some examples, the first end 142 of the first mesh sleeve 114 is closed before the first mesh sleeve 114 is slid over the plastic sleeve 112.

FIG. 16 depicts the closed second end 144 of the first mesh sleeve 114. As shown in FIG. 16, the second end 144 of the first mesh sleeve 114 is closed with tape 154 wrapped around the second end 144 of the first mesh sleeve 114. In some examples, the tape 154 is also wrapped around a portion of the plastic sleeve 112. In some examples, the tape 154 helps to secure the first mesh sleeve 114 in place over the plastic sleeve 112. In some examples, the first mesh sleeve 114 terminates at a point that is adjacent to the first transition housing 136 between the first transition housing 136 and the first end 111 of the breakout assembly 110. In some examples, as shown in FIG. 16, the second end 144 of the first mesh sleeve 114 is secured over the plastic sleeve 112 before the second end 126 of the plastic sleeve 112 is closed.

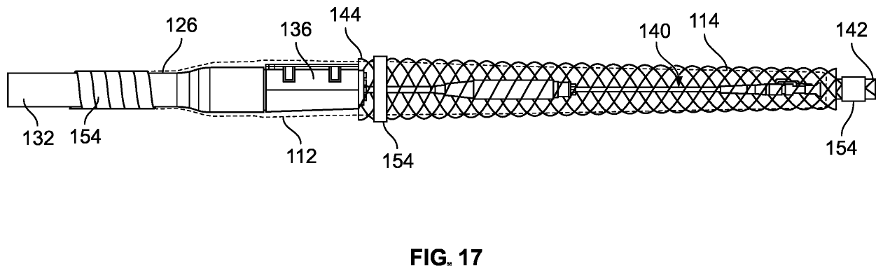

FIG. 17 is a schematic of the first mesh sleeve 114 secured over the plastic sleeve 112, with the closed second end 126 of the plastic sleeve 112, as formed in operation 210.

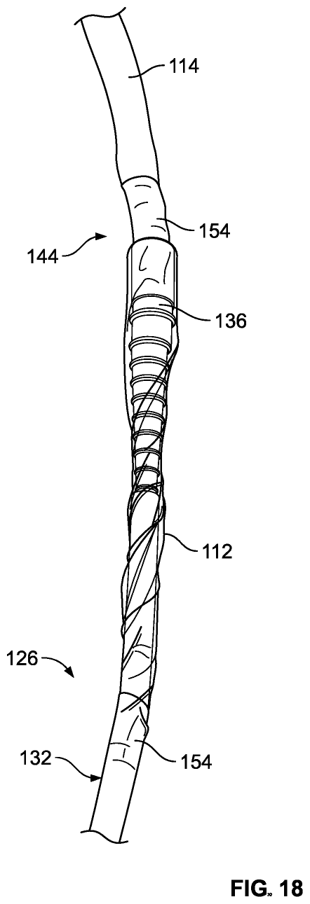

FIG. 18 depicts a zoomed in view of the closed second end 126 of the plastic sleeve 112, as formed in operation 210.

Operation 210 includes closing the second end 126 of the plastic sleeve 112 over the breakout assembly 110. In some examples, operation 210 is performed after operation 208. In some examples, operation 210 is performed before operation 208. In some examples, operation 210 is performed before operation 206. In some examples, prior to closing the second end 126 of the plastic sleeve 112, air is forced out of the plastic sleeve 112 from the space between the closed second end 144 of the first mesh sleeve 114 and the second end 126 of the plastic sleeve 112. In some examples, this is done in part by pulling on the first mesh sleeve 114 to reduce the inner diameter of the first mesh sleeve 114 to compress the plastic sleeve 112. Plastic sleeve 112 at the second end 126 is compressed and twisted around the breakout assembly 110. In some examples, the plastic sleeve 112 is compressed and twisted around the first transition housing 136 and the cable jacket 132. In some examples, the second end 126 of the plastic sleeve 112 is secured to the breakout assembly 110 by using tape 154 to seal the plastic sleeve 112 to the breakout assembly 110. In some examples, the tape 154 is used to seal the plastic sleeve 112 to the cable jacket 132 of the breakout assembly 110. In some examples, the tape 154 is wrapped around a portion of the plastic sleeve 112 and is also wrapped around a portion of the cable jacket 132. In some examples closing the second end 126 of the plastic sleeve 112 over the breakout assembly 110 includes forming a watertight and airtight seal between the plastic sleeve 112 and the breakout assembly 110.

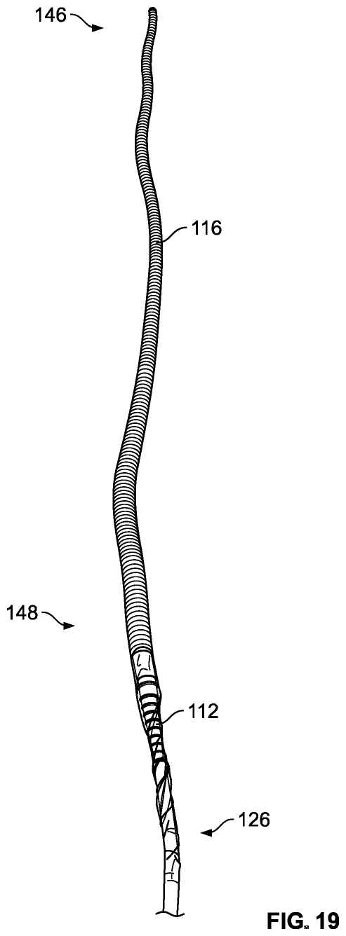

FIG. 19 depicts the crush resistant jacket 116 arranged over the first mesh sleeve 114, as formed in operation 212.

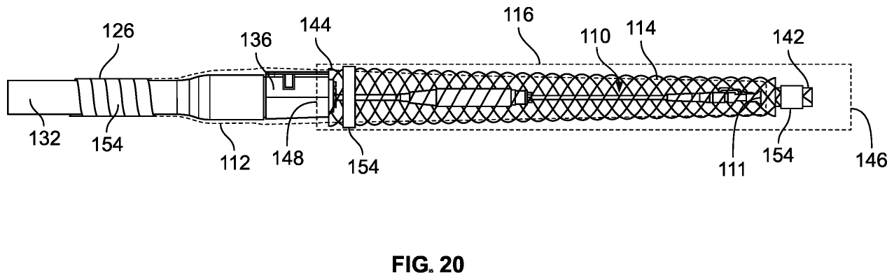

FIG. 20 is a schematic of the crush resistant jacket 116 arranged over the first mesh sleeve 114, as formed in operation 212.

Operation 212 includes arranging the crush resistant jacket 116 over the first mesh sleeve 114. In some examples, the crush resistant jacket 116 is arranged over the first mesh sleeve 114 while the ends of the first mesh sleeve 114 are closed and the ends of the plastic sleeve 112 are closed. In some examples, arranging the crush resistant jacket 116 over the first mesh sleeve 114 includes inserting the first end 142 of the first mesh sleeve 114 into the second end 148 of the crush resistant jacket 116 and sliding the crush resistant jacket 116 along the length of the first mesh sleeve 114 until the first end 146 of the crush resistant jacket 116 is arranged adjacent to the first end 142 of the first mesh sleeve 114. In some examples, the crush resistant jacket 116 is arranged such that the first end 146 of the crush resistant jacket 116 extends over and past the first end 111 of the breakout assembly 110. In some examples, the crush resistant jacket 116 is arranged such that the first end 146 of the crush resistant jacket 116 extends over and past the first end 111 of the breakout assembly 110 by at least 1.5 inches. In some examples, the crush resistant jacket 116 extends over and past the first end 142 of the first mesh sleeve. In some examples, the crush resistant jacket 116 is sufficiently long such that when the first end 146 of the crush resistant jacket 116 is arranged adjacent to and over the first end 142 of the first mesh sleeve 114, the second end 148 of the crush resistant jacket 116 extends past the second end 144 of the first mesh sleeve 114. In some examples, the crush resistant jacket 116 is shorter than the length of the plastic sleeve 112 such that when the crush resistant jacket 116 is arranged over the first mesh sleeve 114 with the first end 146 of the crush resistant jacket 116 arranged adjacent to first end 142 of the first mesh sleeve 114, the second end 148 of the crush resistant jacket 116 is arranged between the first end 124 and the second end 126 of the plastic sleeve 112. In some examples, the second end 148 of the crush resistant jacket 116 extends over and past the first transition housing 136. In other examples, the second end 148 of the crush resistant jacket 116 terminates at the first transition housing 136 when the crush resistant jacket 116 is arranged over the first mesh sleeve 114.

In some examples, the outer surface of the first mesh sleeve 114 and the inner surface of the crush resistant jacket 116 are formed such that there is a relatively low amount of friction between the outer surface of the first mesh sleeve 114 and the inner surface of the crush resistant jacket 116. This facilitates the sliding of the crush resistant jacket 116 onto and off of the first mesh sleeve 114.

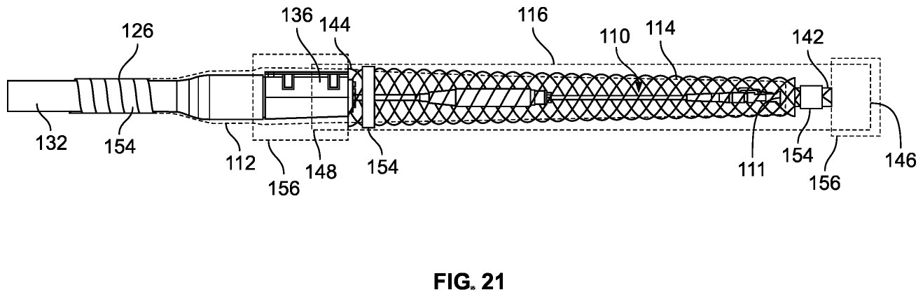

FIG. 21 is a schematic of the crush resistant jacket 116 with the first end 146 and the second end 148 of the crush resistant jacket 116 secured, as formed in operation 214.

Operation 214 includes closing the ends of the crush resistant jacket 116. In some examples, operation 214 includes closing both the first end 146 and the second end 148 of the crush resistant jacket 116 so as to prevent the crush resistant jacket 116 from sliding out of place from its position over the first mesh sleeve 114. In some examples, operation 214 includes closing both the first end 146 and the second end 148 of the crush resistant jacket 116 with a sealing material.

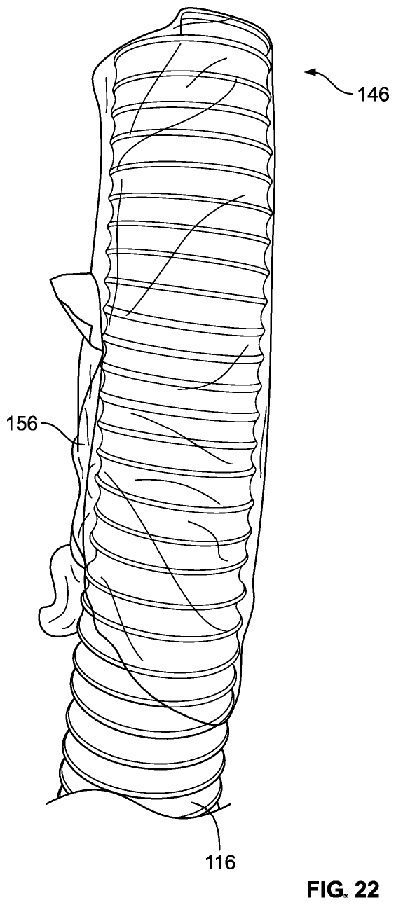

FIG. 22 is a zoomed in view depicting the closed first end 146 of the crush resistant jacket 116. As shown in FIG. 22, the first end 146 of the crush resistant jacket 116 is closed with stretch wrap 156. In some examples, the first end 146 of the crush resistant jacket 116 is closed with another type of sealing material, such as, for example, heat shrink or tape. In some examples, closing the first end 146 of the crush resistant jacket 116 with shrink wrap helps to prevent the first mesh sleeve 114 from sliding out the first end 146 of the crush resistant jacket 116. In some examples, the first end of the crush resistant jacket 116 is secured by other means, such as with tape or heat shrink.

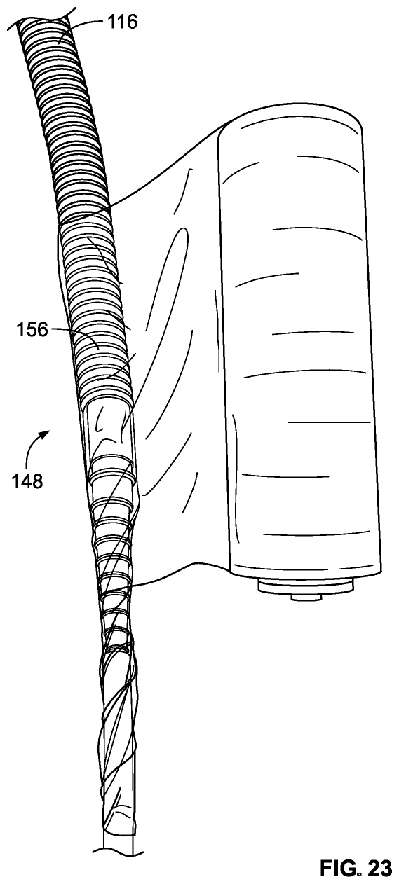

FIG. 23 is a zoomed in view depicting the closed second end 148 of the crush resistant jacket 116. As shown in FIG. 23, the second end 148 of the crush resistant jacket 116 is closed with stretch wrap 156. In some examples, the second end 148 of the crush resistant jacket 116 is closed with another type of sealing material, such as, for example, heat shrink or tape. In some examples, closing the second end 148 of the crush resistant jacket with stretch wrap 156 helps to prevent the crush resistant jacket 116 from sliding out of place. In some examples, as shown in the example of FIG. 23, the stretch wrap 156 is wrapped around both the second end 148 of the crush resistant jacket 116 and a portion of the length of the plastic sleeve 112 adjacent the second end 148 of the crush resistant jacket 116.

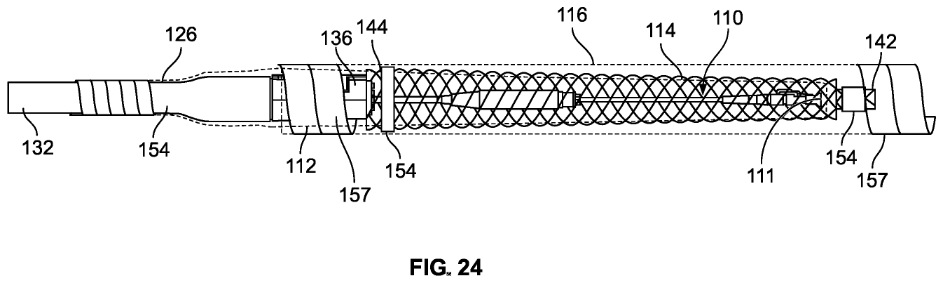

FIG. 24 is a schematic of the crush resistant jacket 116 with the first end 146 and the second end 148 of the crush resistant jacket 116 covered in weather resistant silicon tape 157. In some examples, the weather resistant silicon tape 157 is used in place of the stretch wrap 156 when securing the first end 146 and the second end 148 of the crush resistant jacket 116. In other examples, the silicon tape 157 is used in conjunction with the stretch wrap 156 when securing the first end 146 and the second end 148 of the crush resistant jacket 116. In some examples, the silicon tape 157 helps to provide additional weather resistance and resiliency to the fiber optic assembly 100. In some examples, an additional plastic sleeve is placed over the crush resistant jacket 116 and secured thereon. In some examples, the provision of an additional plastic sleeve secured over the crush resistant jacket 116 provides further environmental protection and weather resistance to the breakout assembly 110. In some examples, the ends of the additional plastic sleeve are secured by heat shrink. In other examples, the ends of the additional plastic sleeve are secured by tape. In some examples, the first end of the additional plastic sleeve, arranged adjacent to the first end 146 of the crush resistant jacket 116 is secured by tape and the second end of the additional plastic sleeve is secured around the cable jacket 132 by tape 154.

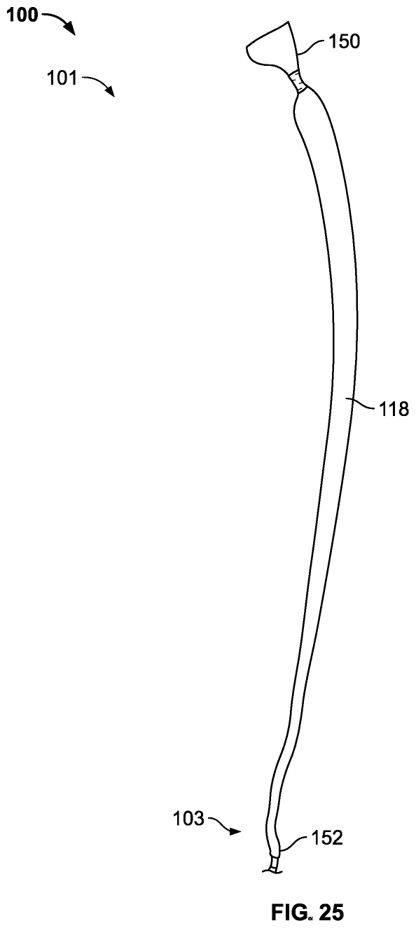

FIG. 25 depicts the fiber optic assembly 100 with the second mesh sleeve 118 arranged over the crush resistant jacket 116 with the ends of the second mesh sleeve 118 closed, as formed in operations 216 and 218.

Operation 216 includes arranging the second mesh sleeve 118 over the crush resistant jacket 116. In some examples, the second mesh sleeve 118 is arranged over the crush resistant jacket 116 while the ends of the crush resistant jacket 116 are closed. In some examples, arranging the second mesh sleeve 118 over the crush resistant jacket 116 includes inserting the first end 146 of the crush resistant jacket 116 into the second end 152 of the second mesh sleeve 118 and sliding the second mesh sleeve 118 over the crush resistant jacket 116 until the first end 150 of the second mesh sleeve 118 is arranged adjacent to the first end 146 of the crush resistant jacket 116. In some examples, the second mesh sleeve 118 is sufficiently long such that when the second mesh sleeve 118 is arranged over the crush resistant jacket 116 such that the first end 150 of the second mesh sleeve 118 is arranged adjacent to the first end 146 of the crush resistant jacket 116, the second end 152 of the second mesh sleeve 118 extends past the second end 126 of the plastic sleeve 112.

Operation 218 includes closing the first end 150 and the second end 152 of the second mesh sleeve 118.

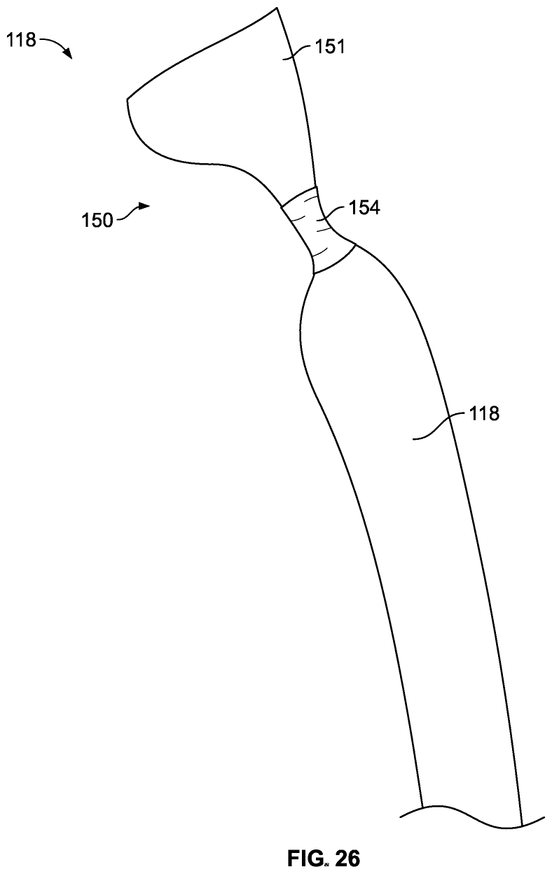

FIG. 26 depicts the closed first end 150 of the second mesh sleeve 118. As shown in FIG. 26, the first end 150 of the second mesh sleeve 118 is closed with tape 154 wrapped around the first end 150 of the second mesh sleeve 118. In other examples, the first end 150 of the second mesh sleeve 118 is closed using other methods, such as tying a knot, using cable ties, or using heat shrink. In some examples, the first end 150 of the second mesh sleeve 118 is closed before the second mesh sleeve 118 is slid over the crush resistant jacket 116. In some examples, the first end 150 of the second mesh sleeve 118 is closed in such a manner as to form a pulling loop 151.

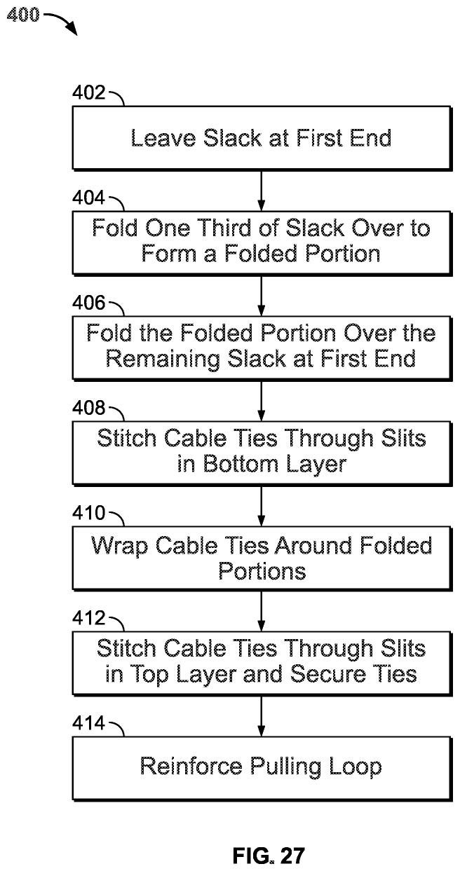

FIG. 27 is a flowchart that depicts an example method 400 of closing the first end 150 of the second mesh sleeve 118. In some examples, the method creates a pulling loop for the fiber optic assembly 100.

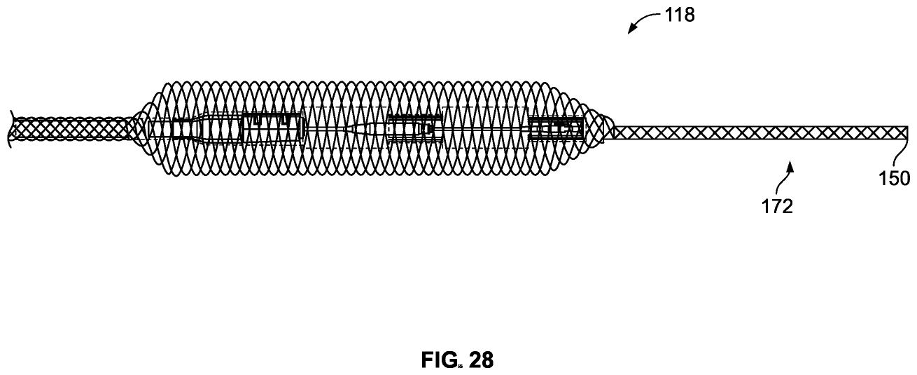

FIG. 28 depicts the second mesh sleeve 118 of operation 402 with the second mesh sleeve 118 arranged over the breakout assembly, 110, the plastic sleeve 112, the first mesh sleeve 114, and the crush resistant jacket 116 with a slack portion 172 of the second mesh sleeve 118 at the first end 150 of the second mesh sleeve 118. In some examples, the slack portion 172 is approximately 12 inches.

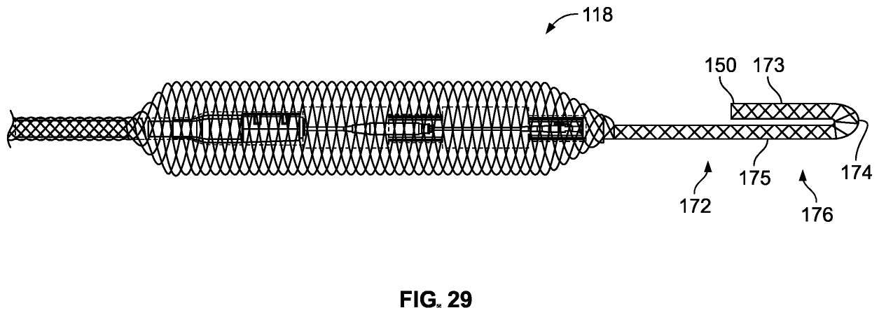

FIG. 29 depicts the second mesh sleeve 118 of operation 404 with a first fold 174. Operation 404 includes folding a first length 173 of the slack portion 172 over top of a second length 175 of the slack portion 172 to create a first folded portion 176. In some examples, the first length 173 and the second length 175 are each approximately one third of the overall length of the slack portion 172.

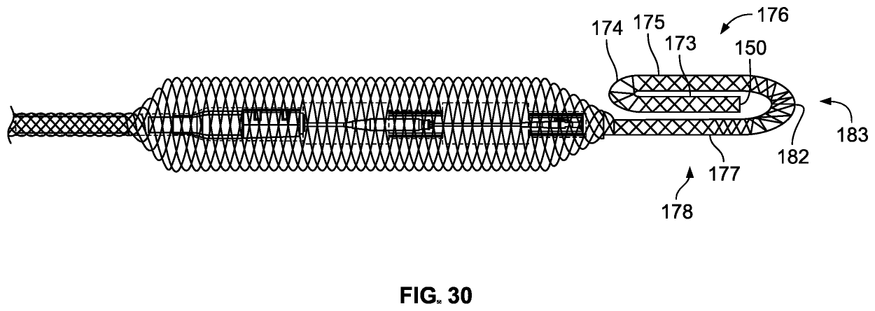

FIG. 30 depicts the second mesh sleeve 118 of operation 406 with a second fold 182. Operation 406 includes folding the first folded portion 176 over a third length 177 of the slack portion 172 to create a second folded portion 178 that includes the first folded portion 176. In some examples, performance of operation 406 creates a pulling loop 183 in the second mesh sleeve 118.

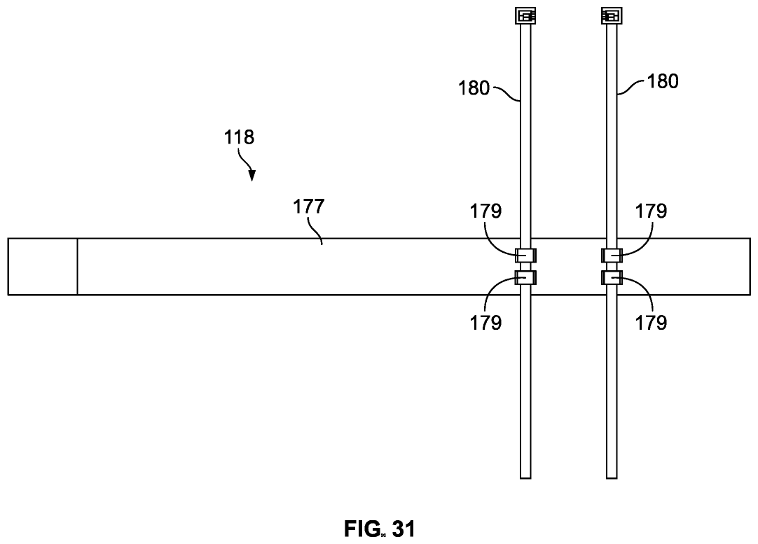

FIG. 31 is a bottom view of the third length 177 of the second mesh sleeve 118 of operation 408. As shown in FIG. 31, the third length 177 of the second mesh sleeve 118 includes a plurality of slits 179 cut therein. In some examples, four slits 179 are cut into the bottom of the third length 177 of the second mesh sleeve 118. In some examples, one or more ties are inserted through the slits 179. In some examples, two cable ties 180 are inserted through the slits 179 such that one cable tie 180 is arranged through two of the slits 179 and the other cable tie 180 is arranged through another two of the slits 179.

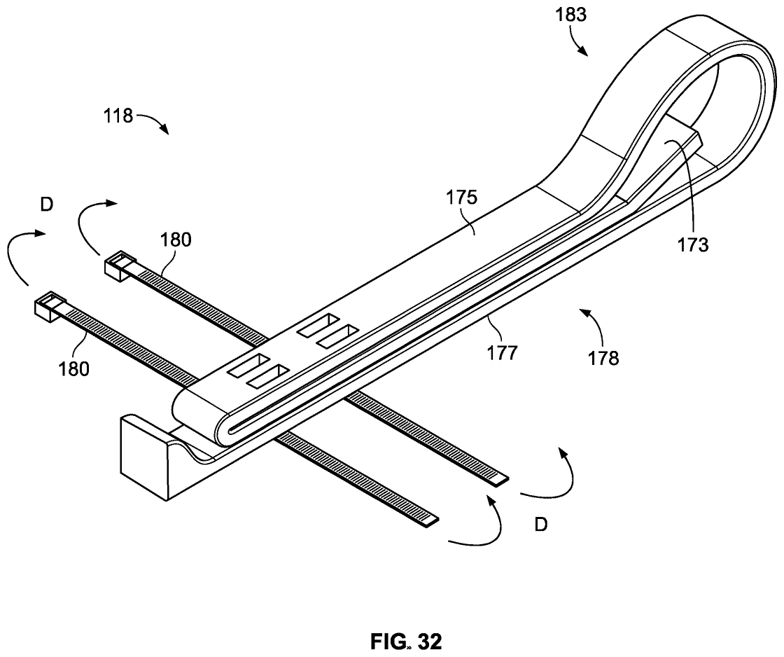

FIG. 32 is a perspective view of the pulling loop 183 of the second mesh sleeve 118 with the cable ties 180 shown in a pre-wrapped orientation. In some examples, in operation 410, the cable ties 180 are wrapped in the direction of arrows D around the first length 173, the second length 175, and the third length 177 of the second mesh sleeve 118.

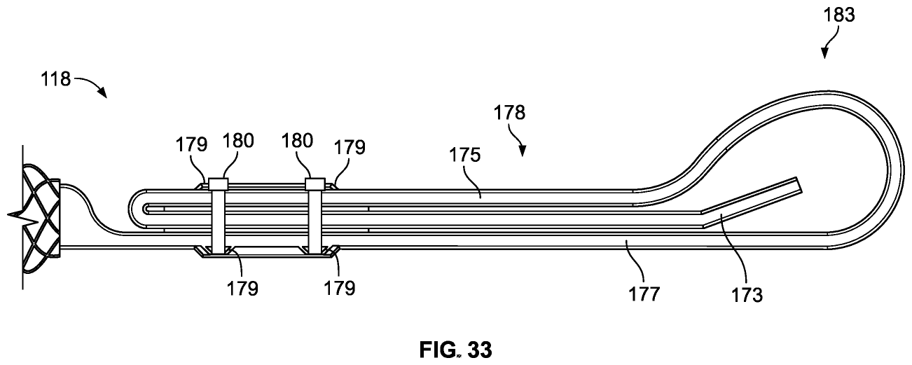

FIG. 33 is a side view of the pulling loop 183 of the second mesh sleeve 118 of operation 412. As shown in FIG. 33, in operation 412, the cable ties 180 are wrapped around the first length 173, the second length 175, and the third length 177 of the second folded portion 178. The cable ties 180 are also stitched through the slits 179 in the second length 175 of the second folded portion 178 and secured into a loop around the second folded portion 178.

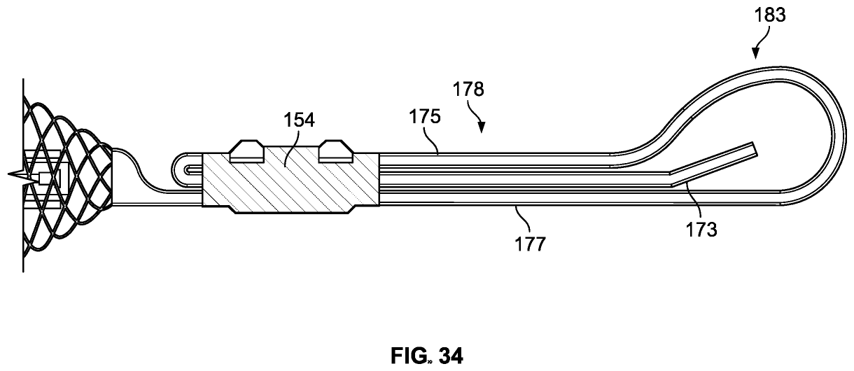

FIG. 34 is a side view of the pulling loop 183 of the second mesh sleeve 118 of operation 412. In operation 412, the pulling loop 183 is reinforced. In some examples, in operation 412, the pulling loop 183 is reinforced by wrapping tape 154 around a portion of the second folded portion 178 such that the cable ties 180 are covered by the tape 154.

In some examples, performance of the method 400 allows for the pulling loop 183 to be created in the second mesh sleeve 118. In some examples, the pulling loop 183 provides a point at which the fiber optic assembly 100 can be grasped and pulled through a conduit. In some examples, the pulling loop 183 is able to withstand approximately 1000 pounds of force.

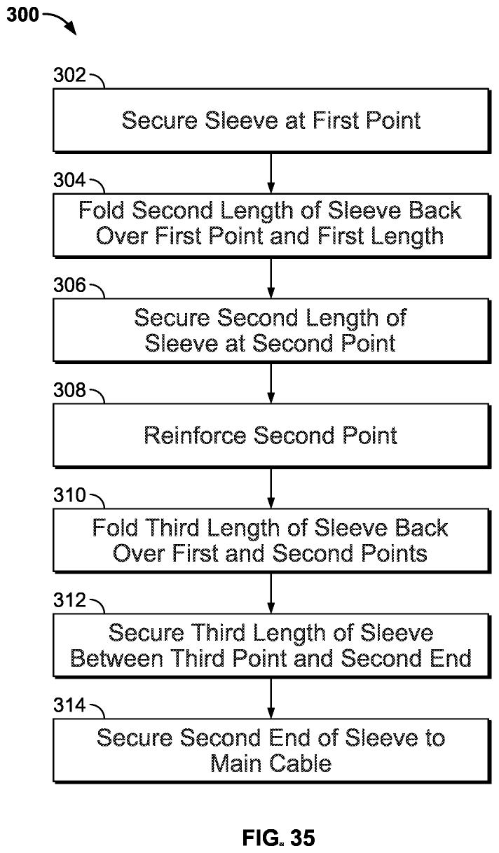

FIG. 35 is a flowchart that depicts an example method 300 of closing the second end 152 of the second mesh sleeve 118. In some examples, the method 300 includes operations 302, 304, 306, 308, 310, 312, and 314.

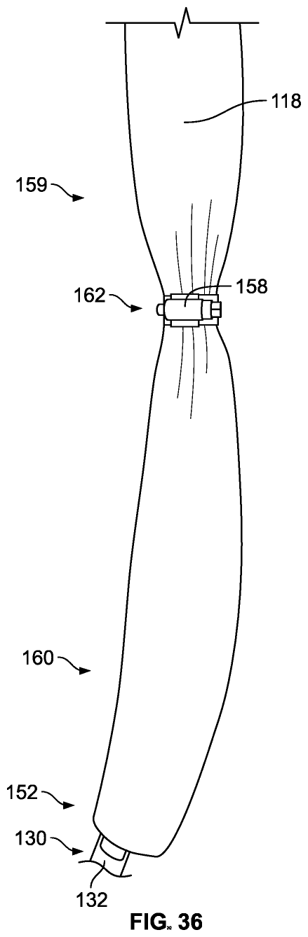

FIG. 36 depicts the second end 152 of the second mesh sleeve 118 with the second mesh sleeve 118 secured at a first point 162, as formed in operation 302. Operation 302 includes securing the second mesh sleeve 118 at the first point 162. In some examples, as depicted in FIG. 36, the second mesh sleeve 118 is secured at the first point 162 by a clamp 158 fastened around the second mesh sleeve 118. In some examples, as shown in FIG. 36, the clamp 158 is a metal hose or cable clamp. In other examples, another securing device may be used in place of a clamp, such as, for example, a cable tie, a zip tie, tape, or heat shrink. In some examples, the clamp 158 is arranged around both the second mesh sleeve 118 and the cable jacket 132 so as to secure the second end 152 of the second mesh sleeve 118 at a point along the main cable 130. In some examples, the clamp 158 is placed along the length of the second mesh sleeve 118 between the first end 150 and the second end 152 of the second mesh sleeve 118 such that there is a first length 159 of the second mesh sleeve 118 that extends between the first point 162 and the first end 150 and a second length 160 of the second mesh sleeve 118 that extends between the first point 162 and the second end 152 of the second mesh sleeve 118. In some examples, the first point 162 is located along the length of the second mesh sleeve 118 at a point between the first transition housing 136 of the breakout assembly 110 and the second end 113 of the breakout assembly 110 when the second mesh sleeve 118 is arranged over the breakout assembly 110.

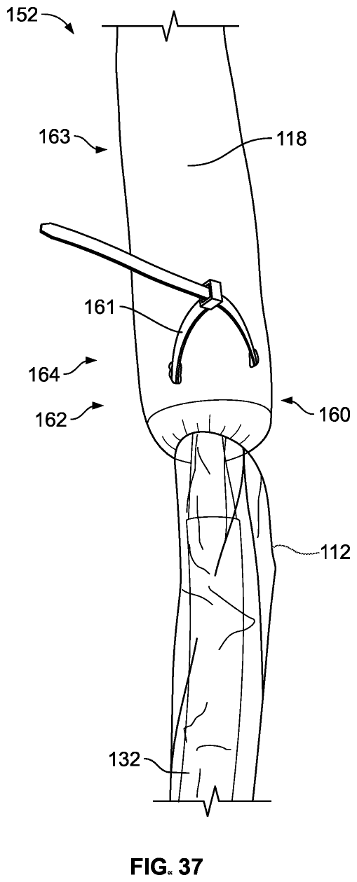

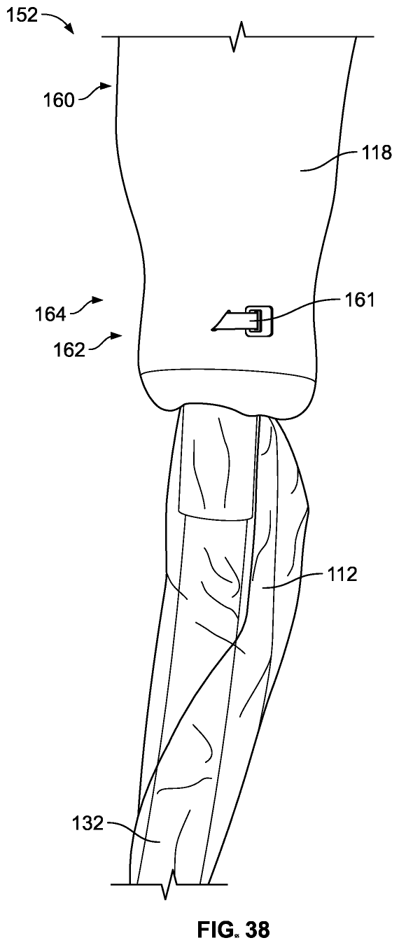

FIGS. 37 and 38 depict the second mesh sleeve 118 with the second length 160 folded back around a portion of the first length 159 and secured at a second point 164, as formed in operations 304 and 306.

Operation 304 includes folding the second length 160 of the second mesh sleeve 118 back around the first point 162. As shown in FIGS. 37 and 38, folding around the second length 160 of the second mesh sleeve 118 around the first point 162 includes pulling the second length 160 of the second mesh sleeve 118 back towards the first end 150 of the second mesh sleeve 118. As shown in FIGS. 37 and 38, the second length 160 of the second mesh sleeve 118 extends around the clamp 158 such that the clamp 158 is arranged within an internal space of the second length 160 of the second mesh sleeve 118.

Operation 306 includes securing the second length 160 of the second mesh sleeve 118 at a second point 164. In some examples, operation 306 includes wrapping a zip tie 161 around a portion of the second mesh sleeve 118 at the second point 164. In some examples, the second point 164 is located at a portion of the second mesh sleeve 118 that is between the first point 162 and the second end 152 of the second mesh sleeve 118 when the second mesh sleeve is in the folded position of FIGS. 37 and 38. In some examples, the second point 164 is located at a point between the first point 162 and the first end 111 of the breakout assembly 110. In some examples, the second mesh sleeve 118 includes a third length 163. In some examples, the second length 160 extends between the first point 162 and the second point 164, while the third length 163 extends between the second point 164 and the second end 152 of the second mesh sleeve 118. In some examples, securing the second length 160 of the second mesh sleeve 118 at the second point 164 includes wrapping an object such as a cable tie, a clamp, or a zip tie around the second length 160 and the first length 159 while the second length 160 is folded around the first length 159. In some examples, such as the example of FIGS. 37 and 38, the zip tie 161 is threaded through slits in the second length 160 of the second mesh sleeve 118 such that a portion of the zip tie 161 is wrapped around both the first length 159 and the second length 160 and a portion of the zip tie 161 is only wrapped around the first length 159 second mesh sleeve 118.

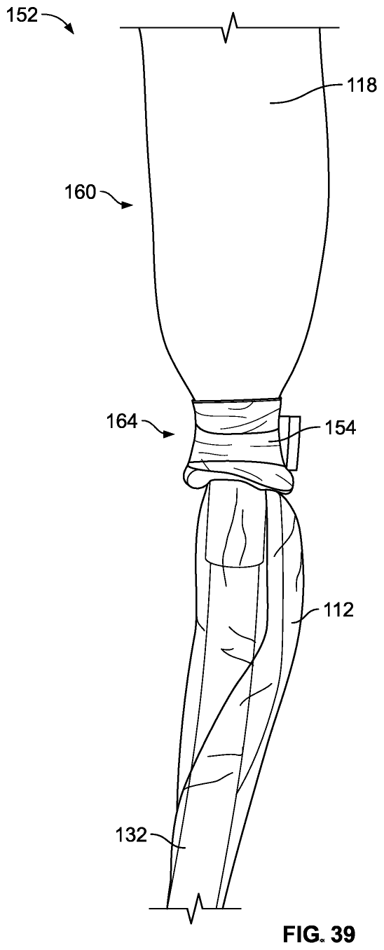

FIG. 39 depicts the second end 152 of the of the second mesh sleeve 118 with a reinforced second point 164, as formed in operation 308. Operation 308 includes reinforcing the second point 164. In some examples, reinforcing the second point 164 includes wrapping tape 154 around the zip tie 161 located at the second point 164 so as to cover the zip tie 161 with tape 154. In some examples, multiple layers of tape 154 are wrapped around the zip tie 161. In some examples, as shown in the example of FIG. 39 the tape 154 is also wrapped around the second length 160 of the second mesh sleeve 118.

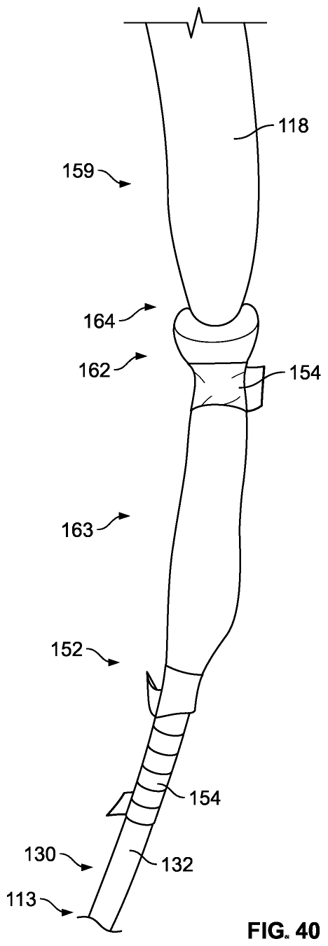

FIG. 40 depicts the second end 152 of the second mesh sleeve 118 with the third length 163 folded back around the second point 164 and the first point 162 and secured, as formed in operations 310, 312, and 314.

In some examples, operation 310 includes folding the third length 163 of the second mesh sleeve 118 back around the second point 164 and the first point 162 towards the second end 113 of the breakout assembly 110. In operation 310, the zip tie 161 is covered by the third length 163 of the second mesh sleeve 118 such that the zip tie 161 is arranged within the third length 163 of the second mesh sleeve 118. In some examples, when the second end 152 of the second mesh sleeve 118 is pulled back towards the second end 113 of the breakout assembly, the second mesh sleeve 118 is sufficiently long such that the third length 163 of the second mesh sleeve 118 extends past the second end 128 of the plastic sleeve 112.

In some examples, operation 312 includes securing the second mesh sleeve 118 along the third length 163 at a point between the second point 164 and the second end 152 of the second mesh sleeve 118. In some examples, operation 312 includes placing tape 154 around the second mesh sleeve 118 along the third length 163 at a point between the first point 162 and the second end 152 of the second mesh sleeve 118.

In some examples, operation 314 includes securing the second end 152 of the second mesh sleeve 118 to the cable jacket 132 of the main cable 130 of the breakout assembly 110. In some examples, operation 312 includes wrapping tape 154 around the second end 152 of the second mesh sleeve 118 and a portion of the cable jacket 132.

In some examples, the second mesh sleeve 118 is a layer at which the fiber optic assembly 100 can be grasped by a user and pulled. In some examples, the second mesh sleeve 118 is strong enough to withstand pulling forces of up to 1000 pounds when the fiber optic assembly 100 is fully assembled.

In some examples, the fiber optic assembly 100 is easily disassembled by a user such that the breakout assembly 110 can be quickly and easily accessed. In some examples, each of the second mesh sleeve 118, the crush resistant jacket 116, the first mesh sleeve 114, the plastic sleeve 112 can be unsecured at the second ends thereof and pulled from the first ends thereof to remove each of the second mesh sleeve 118, the crush resistant jacket 116, the first mesh sleeve 114, and the plastic sleeve 112 from their position around the breakout assembly 110. In some examples, more than one of the second mesh sleeve 118, the crush resistant jacket 116, the first mesh sleeve 114, and the plastic sleeve 112 may be removed simultaneously.

The various embodiments described above are provided by way of illustration only and should not be construed to limit the claims attached hereto. Those skilled in the art will readily recognize various modifications and changes that may be made without following the example embodiments and applications illustrated and described herein, and without departing from the full scope of the following claims.

What is claimed is:

1. A fiber optic assembly comprising:
a plurality of fiber optic cables forming an inner cable breakout assembly;
a plastic sleeve around the inner cable breakout assembly;
a first mesh sleeve around the plastic sleeve;
a crush resistant jacket around the first mesh sleeve; and
a second mesh sleeve around the crush resistant jacket.

2. The fiber optic assembly of claim 1, wherein the crush resistant jacket is a corrugated tubing.

3. The fiber optic assembly of claim 1, wherein the plastic sleeve is closed at a first end thereof, and wherein the first mesh sleeve extends over the closed first end of the plastic sleeve.

4. The fiber optic assembly of claim 3, wherein the inner cable breakout assembly includes a first end, wherein the plastic sleeve extends over the first end of the inner cable breakout assembly, and wherein the first end of the inner cable breakout assembly is arranged adjacent the closed first end of the plastic sleeve.

5. The fiber optic assembly of claim 4, wherein the first end of the plastic sleeve is closed by one of a knot tied in the plastic sleeve, tape wrapped around the plastic sleeve, or heat sealing.

6. The fiber optic assembly of claim 4, wherein the first mesh sleeve is closed at a first end thereof, and wherein the closed first end of the first mesh sleeve is arranged adjacent the closed first end of the plastic sleeve.

7. The fiber optic assembly of claim 6, wherein the first end of the first mesh sleeve is closed by one of a knot tied in the first mesh sleeve, tape wrapped around the first mesh sleeve, a cable tie wrapped around the first mesh sleeve, or heat shrink.

8. The fiber optic assembly of claim 6,
wherein the first mesh sleeve extends away from the closed first end of the first mesh sleeve to a second end of the first mesh sleeve,
wherein the plastic sleeve extends away from the closed first end of the plastic sleeve to a second end of the plastic sleeve, the second end of the plastic sleeve being located further from the first end of the inner cable breakout assembly than the second end of the first mesh sleeve;
wherein the second end of the first mesh sleeve is secured around the plastic sleeve between the first end of the plastic sleeve and the second end of the plastic sleeve; and
wherein the second end of the plastic sleeve is secured around the inner cable breakout assembly.

9. The fiber optic assembly of claim 8,
wherein the second mesh sleeve extends over the closed first end of the first mesh sleeve; and
wherein the second mesh sleeve is closed at a first end thereof, and wherein the closed first end of the second mesh sleeve is arranged adjacent the closed first end of the first mesh sleeve.

10. The fiber optic assembly of claim 9,
wherein the second mesh sleeve further includes a second end, the second mesh sleeve being secured around the inner cable breakout assembly at a first point along the second mesh sleeve, the first point being located between the first end and the second end of the second mesh sleeve, the second mesh sleeve including a first length between the first end and the first point and a second length between the first point and the second end;
wherein the second length of the second mesh sleeve is folded back around itself and extends over the first point and a portion of the first length;
wherein the second length is secured over the first point of the second mesh sleeve at a second point along the second length of the second mesh sleeve, the second point being located between the first point and the second end of the second mesh sleeve;
where a third length of the second mesh sleeve between the second point and the second end of the second mesh sleeve is folded back around itself and extends over the second point on the second mesh sleeve and the cable breakout assembly; and
wherein the second end is secured around the cable breakout assembly.

11. A method of assembling a fiber optic assembly, the method comprising:
pulling a plastic sleeve over a plurality of fiber optic cables, the plurality of fiber optic cables forming an inner cable breakout assembly;
pulling a first mesh sleeve over the plastic sleeve; and
pulling a crush resistant jacket over the first mesh sleeve.

12. The method of claim 11, further comprising closing a first end of the plastic sleeve such that when the plastic sleeve is pulled over the inner cable breakout assembly, an end of the inner cable breakout assembly is arranged within the plastic sleeve adjacent to the closed first end of the plastic sleeve.

13. The method of claim 12, wherein the first end of the plastic sleeve is closed by one of a knot tied in the plastic sleeve, tape wrapped around the plastic sleeve, or heat sealing.

14. The method of claim 12, further comprising closing the first end of the first mesh sleeve such that when the first mesh sleeve is pulled over the plastic sleeve, the first end of the plastic sleeve is arranged within the first mesh sleeve adjacent to the closed first end of the first mesh sleeve.

15. The method of claim 14, wherein the first end of the first mesh sleeve is closed by one of a knot tied in the first mesh sleeve, tape wrapped around the first mesh sleeve, a cable tie wrapped around the first mesh sleeve, or heat shrink.

16. The method of claim 14, further comprising securing a second end of the plastic sleeve around the inner cable breakout assembly.

17. The method of claim 16, further comprising securing a second end of the first mesh sleeve around the plastic sleeve at a point between the first end and the second end of the plastic sleeve.

18. The method of claim 17, further comprising pulling a second mesh sleeve over the crush resistant jacket.

19. The method of claim 18, further comprising closing a first end of the second mesh sleeve such that when the second mesh sleeve is pulled over the crush resistant jacket, the first end of the crush resistant jacket is arranged within the second mesh sleeve adjacent to the closed first end of the second mesh sleeve.

20. The method of claim 19, further comprising:
securing the second mesh sleeve around the inner cable breakout assembly at a first point along the second mesh sleeve, the first point being located between the first end and the second end of the second mesh sleeve, the second mesh sleeve including a first length between the first end and the first point and a second length between the first point and the second end;
folding the second length of the second mesh sleeve back around itself such that the second length extends over the first point on the second mesh sleeve and a portion of the first length;
securing the second length over the first point of the second mesh sleeve at a second point along the second mesh sleeve, the second point being located between the first point and the second end of the second mesh sleeve;
folding a third length of the second mesh sleeve back around itself such that the third length extends over the second point on the second mesh sleeve, the third length comprising a portion of the second mesh sleeve between the second point on the second mesh sleeve and the second end of the second mesh sleeve; and
securing the second end of the second mesh sleeve around the cable breakout assembly.

21. The method of claim 11, further comprising pulling a second mesh sleeve over the crush resistant jacket.

22. The method of claim 11, further comprising pushing the second end of the first mesh sleeve toward the first end of the first mesh sleeve to increase a diameter of the first mesh sleeve.

23. The method of claim 11, further comprising pulling the second end of the first mesh sleeve away from the first end of the first mesh sleeve to decrease a diameter of the first mesh sleeve, while the first mesh sleeve is positioned over the inner cable breakout assembly, and before pulling the crush resistant jacket over the first mesh sleeve.

24. The method of claim 23, further comprising pulling a second mesh sleeve over the crush resistant jacket.
